(19) United States
(12) Patent Application Publication
(10) Pub. No.: US 2011/0000582 A1
(43) Pub. Date: Jan. 6, 2011

(54) LOG DEBARKING ASSEMBLY

(75) Inventor: Jean-Guy Bouchard, Macamic (CA)

Correspondence Address: FRASER CLEMENS MARTIN & MILLER LLC, 28366 KENSINGTON LANE, PERRYSBURG, OH, 43551, US

(73) Assignee: 9143-4316 QUEBEC INC., Macamic (CA)

(21) Appl. No.: 12/825,396

(22) Filed: Jun. 29, 2010

Related U.S. Application Data
(60) Provisional application No. 61/270,127, filed on Jul. 2, 2009.

(51) Int. Cl. B27L 1/10; B23Q 15/22

(52) U.S. Cl. 144/408; 144/417; 144/208.91

(57) ABSTRACT

The log debarking assembly comprises an auto-aligning ring debarker that in turn comprises a base, a movable frame carried by the base and movable relative to the base, a log opening formed in the movable frame, a ring-type cutting tool mounted to the movable frame and protruding in the log opening, the cutting tool for debarking logs that are fed through the log opening, and a powered debarker actuator assembly capable of selectively moving the movable frame relative to the base. The log debarking assembly also comprises a log shape and position detector comprising a scanner located upstream of the debarker for detecting the shape and position of logs at the location of the scanner and for generating log data as a result of detected log shape and position at the location of the scanner; and a control device capable of receiving the log data and of controlling the powered debarker actuator assembly as a result of the log data. The position of the movable frame may consequently be adjusted for adjusting the position of the log opening and the cutting tool relative to the logs being fed through the log opening to be debarked.

### CROSS-REFERENCE DATA

The present application claims the priority of U.S. provisional patent application No. 61/270,127 filed on Jul. 2, 2009.

### FIELD OF THE INVENTION

The present invention relates to log debarking assemblies for use in removing bark from logs and more particularly to one that includes a log debarker that has an auto-alignment capability to accommodate varying shapes and inked positions of logs.

### BACKGROUND OF THE INVENTION

Log debarkers are known devices used to remove bark from logs before the logs are processed through other log processing apparatuses, for example a log-cutting apparatus for producing lumber. Nowadays, the wood-production line is automated and includes log conveyors that convey the logs to and from the debarker.

Log debarkers come in different shapes and types. One known type is the so-called ring debarker that includes a number of blades concentrically mounted on a ring that is in turn rotatably mounted to a fixed frame. The blades protrude in a log opening formed in the frame through which the logs will be processed. The blades are pivotally attached to the ring and are spring-biased towards a rest position in which they extend generally towards the center of the ring. The blades may be pivoted away from this rest position against this spring-bias to form a passage centrally located between the blades to allow logs being processed through the debarker to pass between the blades. The ring of blades will rotate about the log to have the blades forcefully engage the log's outer surface under the spring-bias to peel the bark off from the log.

A log debarker must endure important stresses as logs are forcefully conveyed through it. Indeed, the logs will be pushed against the blades and it is the forward movement of the log through the debarker that will force the blades to spread apart to allow the log to pass through and between the blades. This imparts significant stresses on the log debarker especially considering the irregular shapes and/or misalignment of the logs being processed. Indeed, a log will usually have a natural curvature, a variable diameter and branch stumps that remain from the delimbing operation, and any two logs will not be identical in shape. As these logs of irregular shapes are fed into the debarker, sometimes not in perfect alignment with the debarker axis, they will engage the blades in a non-centered, misaligned fashion, thereby being forced more against blades on one side of the debarker and less against other blades on the other side. This may result not only in the log not being properly debarked, but also in even more important stresses being induced in the log debarker. To mitigate this problem, sturdier, heavier and more expensive equipment needs to be used.

### SUMMARY OF THE INVENTION

The present invention relates to a log debarking assembly for removing bark from logs and defining an upstream end for logs to be debarked to be fed into said log debarking assembly and a downstream end for debarked logs to be outputted, said log debarking assembly comprising:
a auto-aligning ring debarker comprising:
   a base;
   a movable frame carried by said base and movable relative to said base;
   a log opening formed in said movable frame;
   a ring-type cutting tool mounted to said movable frame and protruding in said log opening, said cutting tool for debarking logs that are fed through said log opening; and
   a powered debarker actuator assembly capable of selectively moving said movable frame relative to said base;
a log shape and position detector comprising a first scanner located upstream of said debarker for detecting the shape and position of logs at the location of said first scanner and for generating first log data as a result of detected log shape and position at the location of said first scanner; and
a control device capable of receiving said first log data and of controlling said powered debarker actuator assembly as a result of said first log data;
   wherein the position of said movable frame may be adjusted for adjusting the position of said log opening and said cutting tool relative to the logs being fed through said log opening to be debarked.

In one embodiment, said movable frame is carried by said base by means of a pivot arm member pivotally attached to said base about a first pivot mount and further pivotally attached to said movable frame about a second pivot mount thus allowing said movable frame to pivot relative to said base about said first and second pivot mounts.

In one embodiment, said powered debarker actuator assembly comprises a first actuator selectively forcing said movable frame to move about said first pivot mount and a second actuator selectively forcing said movable frame to move about said second pivot mount.

In one embodiment, said movable frame comprises opposite first and second ends, with said pivot arm member and said first and second actuators being linked to said movable frame near said first end and with said log opening being located near said second end, said movable frame second end thus being supported in cantilever fashion.

In one embodiment, said first actuator comprises a first hydraulic cylinder having a first end linked to said base and a second end linked to said pivot arm member away from said first pivot mount towards said second pivot mount, with the retraction and extraction of said first hydraulic cylinder resulting in pivotal displacement of both said pivot arm member and said movable frame about said first pivot mount.

In one embodiment, said second actuator comprises at least one second hydraulic cylinder parallel to and spaced from said pivot arm member and having a first end linked to said base and a second end linked to said movable frame, with the retraction and extraction of said second hydraulic cylinder resulting in pivotal displacement of said movable frame about said second pivot mount.

In one embodiment, said log debarking assembly further comprises an inlet conveyor located upstream of said debarker for feeding logs into said debarker, with said first scanner located upstream of said debarker and downstream of said inlet conveyor for detecting the shape and position of logs between said debarker and said inlet conveyor and for generating said first log data as a result of detected log shape and position between said debarker and said inlet conveyor.

In one embodiment, the position of said inlet conveyor is adjustable by means of a powered inlet conveyor actuator assembly for allowing the position of said log to be adjusted as it is fed towards said debarker.

In one embodiment, said log shape and position detector comprises a second scanner located upstream of said inlet conveyor for detecting the shape and position of logs upstream of said inlet conveyor and for generating second log data as a result of detected log shape and position upstream of said inlet conveyor, with said control device receiving said second log data and controlling said powered debarker actuator assembly and said inlet conveyor actuator assembly as a result of said first and second log data.

In one embodiment, said log debarking assembly further comprises an outlet conveyor located downstream of said debarker for receiving and outputting logs exiting said debarker.

In one embodiment, the position of said outlet conveyor is adjustable by means of a powered outlet conveyor actuator assembly for allowing the position of said log to be adjusted as it exits said debarker but is still partly engaged in said debarker.

In one embodiment, said log position and shape detector comprises a third scanner to located downstream of said debarker and upstream of said outlet conveyor for detecting the shape and position of logs between said debarker and said outlet conveyor and for generating third log data as a result of detected log shape and position between said outlet conveyor and said debarker, with said control device receiving said third log data and controlling said powered debarker actuator assembly and said inlet and outlet conveyor actuator assemblies as a result of said first, second and third log data.

In one embodiment, said log shape and position detector comprises a fourth scanner located downstream of said outlet conveyor for detecting the shape and position of logs downstream of said outlet conveyer and for generating fourth log data as a result of detected log shape and position downstream of said outlet conveyor, with said control device receiving said fourth log data and controlling said powered debarker actuator assembly and said inlet and outlet conveyor actuator assemblies as a result of said first, second, third and fourth log data.

### DESCRIPTION OF THE DRAWINGS

In the annexed drawings:

FIG. 1 is a perspective view from the top, the left-hand side and the upstream end, of the log debarking assembly of the present invention, with the control device and the scanners of the log shape and position detector being shown schematically and with a log L being shown engaging the log debarking assembly;

FIG. 2 is similar to FIG. 1, but with the perspective view being from the top, right-hand side and the downstream end;

FIG. 3 is a perspective view from the top, the left-hand side and the upstream end of the debarker of the log debarking assembly of FIGS. 1 and 2;

FIG. 4 is a perspective view from the top, the right-hand side and the downstream end of the debarker of the log debarking assembly of FIGS. 1 and 2;

FIG. 5 is a downstream elevation of the debarker of FIGS. 3-4; and

FIG. 6 is a downstream elevation of the debarker of FIGS. 3-5 wherein the debarker is further equipped with positional sensors.

### DETAILED DESCRIPTION OF THE EMBODIMENTS

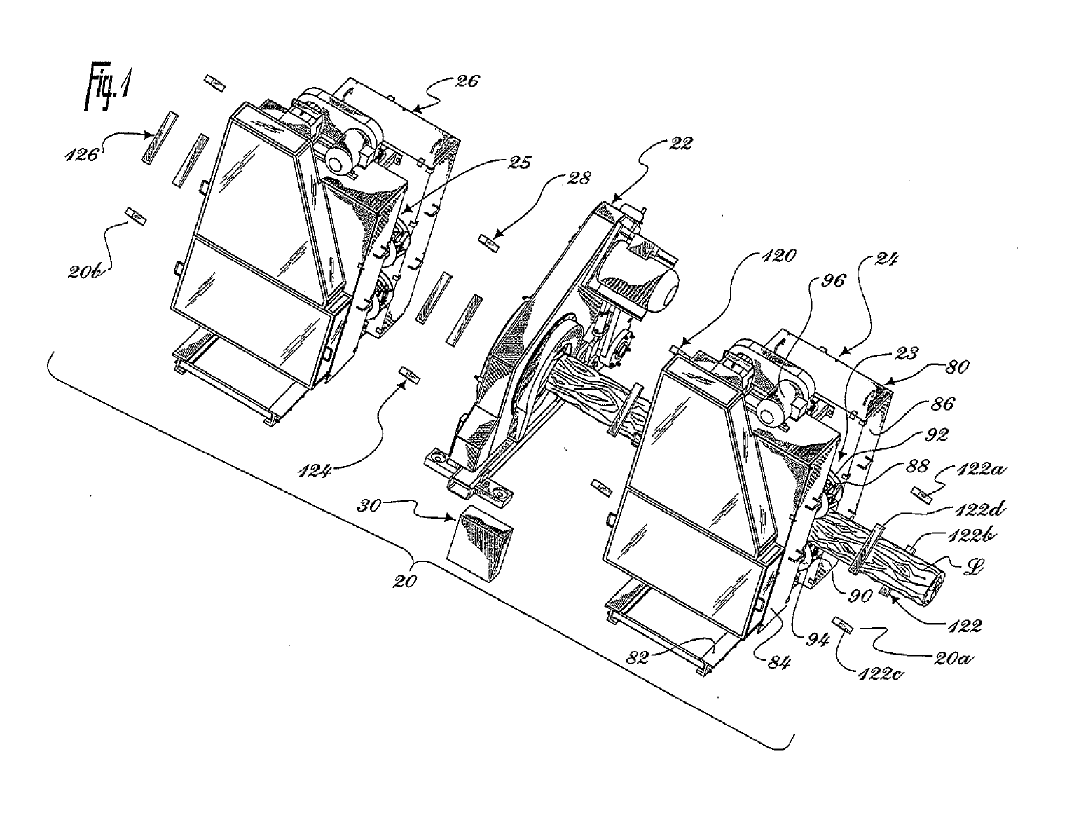

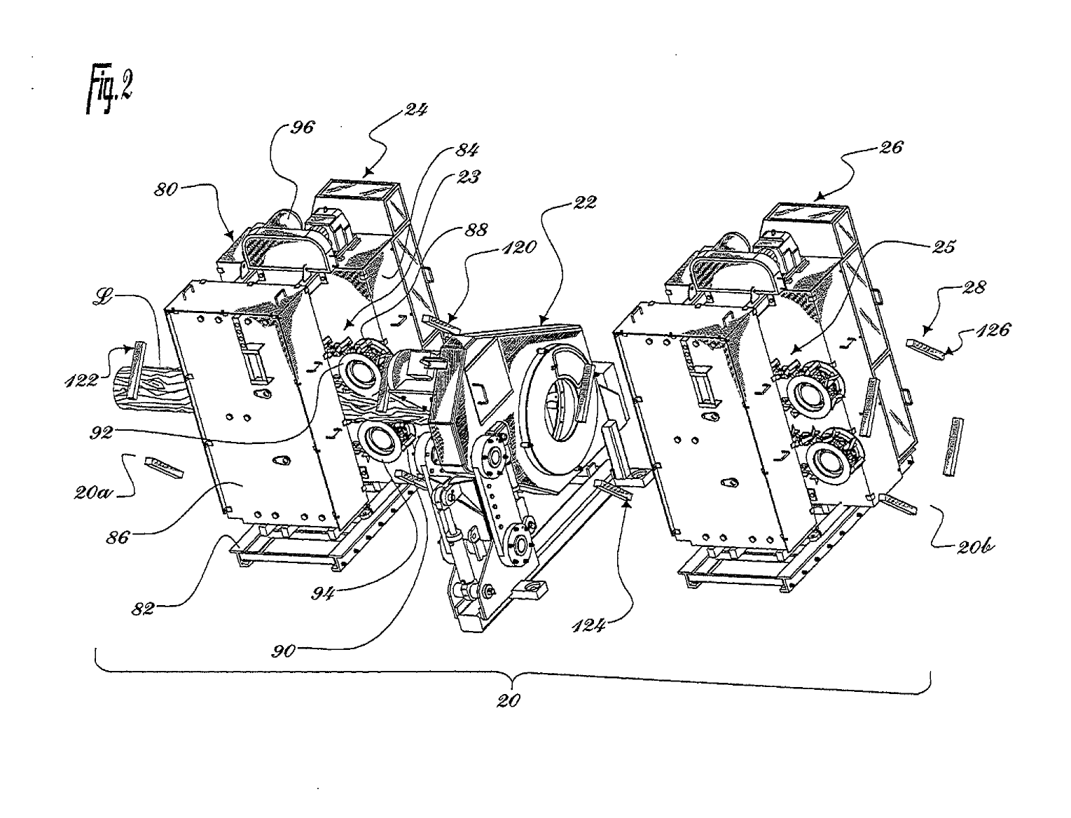

FIGS. 1 and 2 show a log debarking assembly 20 for removing bark from a logs and defining an upstream end 20a where logs to be debarked are fed into log debarking assembly 20 and a downstream end 20b where debarked logs are outputted. A longitudinal axis is defined between the log debarking assembly upstream and downstream ends. Generally, log debarking assembly 20 comprises a debarker 22 that removes bark from logs, an inlet conveyor 23 near upstream end 20a that feeds logs into derbarker 22, an outlet conveyor 25 near downstream end 20b that receives logs that exit debarker 22, a log shape and position detector 28 that detects the shape and position of logs and a control device 30 that controls the position of debarker 22 and inlet and outlet conveyors 24, 26 as a result of the detected log shape and position. A log L to be debarked is schematically shown in FIGS. 1 and 2 to extend from upstream end 20a of debarking assembly 20 to just short of debarker 22 as it is about to be processed through debarker 22.

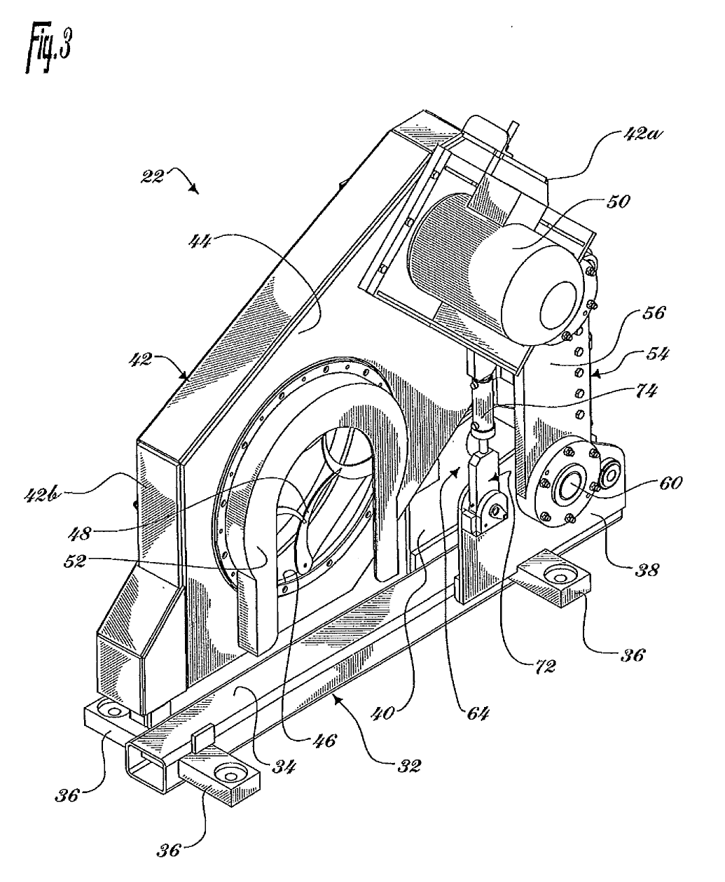

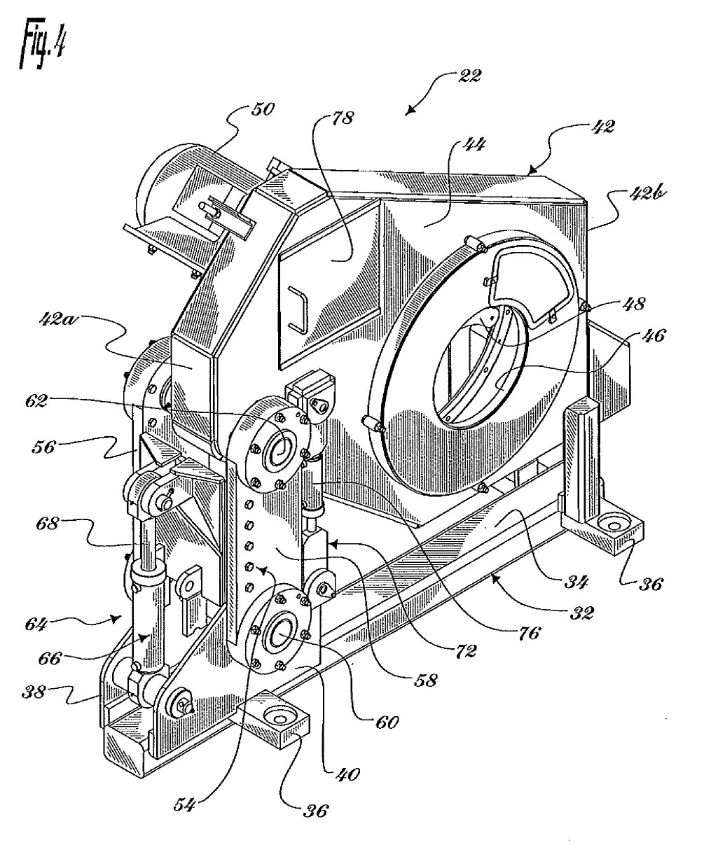

FIGS. 3 and 4 show that debarker 22 comprises a base 32 that has an elongated ground-resting joist 34 to which wings 36 are attached near both ends thereof. Wings 36 extend away from joist 34 and can be riveted to the ground so as to securely fix debarker 22 to the ground. A pair of parallel pivot support plates 38, 40 are fixedly attached to joist 34 in upstanding fashion at one end thereof.

Debarker 22 also comprises a movable frame 42 carried by base 32 and movable relative to base 32. Frame 42 comprises a housing 44 having a log opening 46 formed therein through which logs will be processed for debarking. A ring-type cutting tool 48 is mounted to movable frame 42 and protrudes in log opening 46. As known in the art, cutting tool 48 comprises a number of blades concentrically mounted on a ring (concealed in the drawings) that is in turn rotatably mounted to frame 42 within housing 44. The blades protrude within opening 46, are pivotally attached to the ring and are spring-biased towards a rest position in which they extend generally towards the center of the ring and of log opening 46. The blades may be forcefully pivoted away from this rest position against this spring-bias to form a passage centrally located between the blades to accommodate logs being processed through the debarker. The ring of blades will rotate about the log to have the blades engage the log's outer surface under the spring-bias to peel and thereby debark a log fed through log opening 46 from an upstream side to a downstream side of movable frame 42. The ring of blades of cutting tool 48 is powered in rotation by a motor 50 supported by frame 42 that transmits movement through suitable gear and chain assembly (located within and concealed by housing 44 in the drawings). A protective skirt 52 is located on the upstream side of frame 22 around opening 46.

Movable frame 42 is carried by base 32 by means of a pivot arm member 54 that comprises a pair of parallel pivot arms 56, 58 both pivotally attached to base 32—and more particularly each to a respective one of the pair of pivot support plates 38, 40—about a first pivot mount 60. Pivot arms 56, 58 of pivot arm member 54 are further pivotally attached to movable frame 42 and more particularly on either side of housing 44 about a second pivot mount 62. This attachment of movable frame 42 to base 32 thus allows movable frame 42 to pivot relative to base 32 about first and second pivot mounts 60, 62 as detailed hereinafter.

Debarker 32 also comprises a powered debarker actuator assembly 64 capable of selectively moving movable frame 42 relative to base 32 about first and second pivot mounts 60, 62. Debarker actuator assembly 64 comprises a first actuator 66 selectively forcing movable frame 42 to move about first pivot mount 60. First actuator 66 comprises a first hydraulic cylinder 68 having a first end linked to base 32 and a second end linked to a transverse plate 70 fixedly attached to both pivot arms 56, 58 of pivot arm member 54. Transverse plate 70 is located away from first pivot mount 60 towards second pivot mount 62. The retraction and extraction of first hydraulic cylinder 68 will consequently result in the concurrent pivotal displacement of pivot arm member 54 and movable frame 42 about first pivot mount 60.

Debarker actuator assembly 64 further comprises a second actuator 72 selectively forcing movable frame 42 to move about second pivot mount 62. Second actuator 72 comprises a pair of second hydraulic cylinders 74, 76 both installed parallel to and spaced from pivot arm member 54 and having a first end linked to base 32 and a second end linked to movable frame 42. The retraction and extraction of second hydraulic cylinders 74, 76 will result in pivotal displacement of movable frame 42 about second pivot mount 62.

Movable frame 42 defines opposite first and second ends 42a, 42b, with pivot arm member 54 and first and second actuators 66, 72 being linked to movable frame 42 near its first end 42a and with log opening 46 being located near its second end 42b. Movable frame second end 42b is thus supported in cantilever fashion.

A maintenance access door 78 is provided on housing 44 to allow access therein, notably to the gear and transmission mechanism that transmits the rotational movement from motor 50 to cutting tool 48.

FIGS. 1 and 2 show that inlet conveyor 23 is part of an inlet conveying apparatus 24 that comprises an inlet conveyor frame 80 movable along tracks 82 that rest on and are fixed to the ground and that extend transversely to the log debarking assembly longitudinal axis. Frame 80 comprises two spaced-apart and integrally linked frame portions 84, 86. Upper and lower endless conveyor chains 88, 90 circulate on respective rollers 92, 94 that are supported by one or both frame portions 84, 86 and that are generally located between frame portions 84, 86. Conveyor chains 88, 90 and rollers 92, 94 form inlet conveyor 23. The position of rollers 92, 94 is adjustable, and more particularly rollers 92, 94 are vertically movable along frame 80, i.e. they may be moved towards and away from tracks 22 to consequently move endless chains 88, 90 correspondingly. This allows inlet conveyor 23 to accommodate logs of different diameters in addition to allowing the position of the logs to be adjusted as it exits inlet conveyor 23. Power means such as a motor with associated gear drive and transmission system 96 allows frame 80 to move along tracks 22 and rollers 92, 94 to move vertically and to rotate. The combination of the inlet conveyor frame 80 which is movable along tracks 82 and of the vertically displaceable rollers 92, 94 form and inlet conveyor actuator assembly for allowing the position of log L to be adjusted both horizontally and vertically as it is fed towards debarker 22 by inlet conveyor 23.

Outlet conveyor 25 is similar to inlet conveyor 23: it is part of an outlet conveying apparatus 26 that includes an outlet conveyor frame 100 movable along ground-resting tracks 102 that are parallel to inlet conveyor tracks 82. Frame 100 comprises linked frame portions 104, 106 that carry endless conveyor chains 108, 110 by means of conveying rollers 112, 114 that are vertically movable along frame 100. Endless conveyor chains 108, 110 and rollers 112, 114 form outlet conveyor 25. A motor and associated gear drive and transmission system 116 powers the displacement of frame 100 on tracks 102 and the rotation and vertical movement of rollers 112, 114. The combination of the outlet conveyor frame 100 which is movable along tracks 102 and of the vertically displaceable rollers 112, 114 forms an outlet conveyor actuator assembly for allowing the position of log L to be adjusted as it exits debarker 22 but is still partly engaged in debarker 22.

Log shape and position detector 28 comprises:
a first scanner 120 located upstream of debarker 22 and downstream of inlet conveyor 23 for detecting the shape and position of logs between debarker 22 and inlet conveyor 23 and for generating first log data as a result of detected log shape and position between debarker 22 and inlet conveyor 23;
a second scanner 122 located upstream of inlet conveyor 23 for detecting the shape and position of logs upstream of inlet conveyor 23 and for generating second log data as a result of detected log shape and position upstream of inlet conveyor 23;
a third scanner 124 located downstream of debarker 22 and upstream of outlet conveyor 25 for detecting the shape and position of logs between debarker 22 and outlet conveyor 25 and for generating third log data as a result of detected log shape and position between outlet conveyor 25 and debarker 22; and
a fourth scanner 126 located downstream of outlet conveyor 25 for detecting the shape and position of logs downstream of outlet conveyer 25 and for generating fourth log data as a result of detected log shape and position downstream of outlet conveyor 25.

In alternate embodiments, three, two or even a single one of scanners 120, 122, 124, 126 could be used. For example, first scanner 120 could be the only scanner used as part of log shape and position detector 28.

Each scanner 120, 122, 124, 126 is only schematically shown in FIGS. 1 and 2 and may be of any suitable type known in the art for allowing log shape and position data to be generated from detected log shape and position at each scanner position. Each scanner, for example second scanner 122, may further comprise several scanner components 122a, 122b, 122c, 122d (collectively referred to as scanner 122) such as cameras or other optical, ultrasonic or other suitable scanner components allowing log shape and position detection. Each scanner 120, 122, 124, 126 is supported by a suitable seamier support structure (not shown) such as ground-resting racks.

Control device 30 may be in the form of a computer or other suitable control circuit or microcontroller. Scanners 120, 122, 124, 126 can transmit data to control device 30 in any suitable manner, either through wired or wireless communication means. Control device 30 may further transmit data to debarker actuator assembly 64 and to the inlet and outlet conveyor actuator assemblies in any suitable manner, either through wired or wireless communication means.

In use, as logs are processed through inlet conveyor 23, debarker 22 and oulet conveyor 25, scanners 120, 122, 124, 126 will transmit first, second, third and fourth log data to control device 30 that are representative of the log shape and position at the respective scanner positions. As a result, control device 30 will control the powered debarker actuator assembly 64 and the powered inlet and outlet conveyor actuator assemblies to move the inlet and outlet conveyors 23, 25 and the debarker movable frame 42. In particular, the displacement of movable frame 42 will allow the adjustment of the position of log opening 46 and cutting tool 48 relative to the logs being fed through log opening 46 for accommodating the shape and position of the logs being debarked while the displacement of the inlet and outlet conveyors 23, 25 will allow the adjustment of the position and angle of the log and more particularly of the log section at the debarker cutting tool position. The desired result is that, at any given time, the section of the log being fed through the debarker log opening 46 will be located generally centrally within log opening 46 and the tangent of the log of this section will be generally parallel to the debarking assembly longitudinal axis. It is understood however that, with logs of irregular outer peripheral surfaces, any given log section is likely not to be perfectly symmetrical; algorithms that calculate optimal log debarking may be used to obtain an optimized debarking process, with these algorithms taking into account the irregular log shapes that are dealt with in practice.

Data acquisition and transmittal from scanners 120, 122, 124, 126 is preferably accomplished continuously, i.e. at very short time intervals, so as to continuously adjust the position of the inlet and outlet conveyors 23, 25 and of debarker movable frame 42.

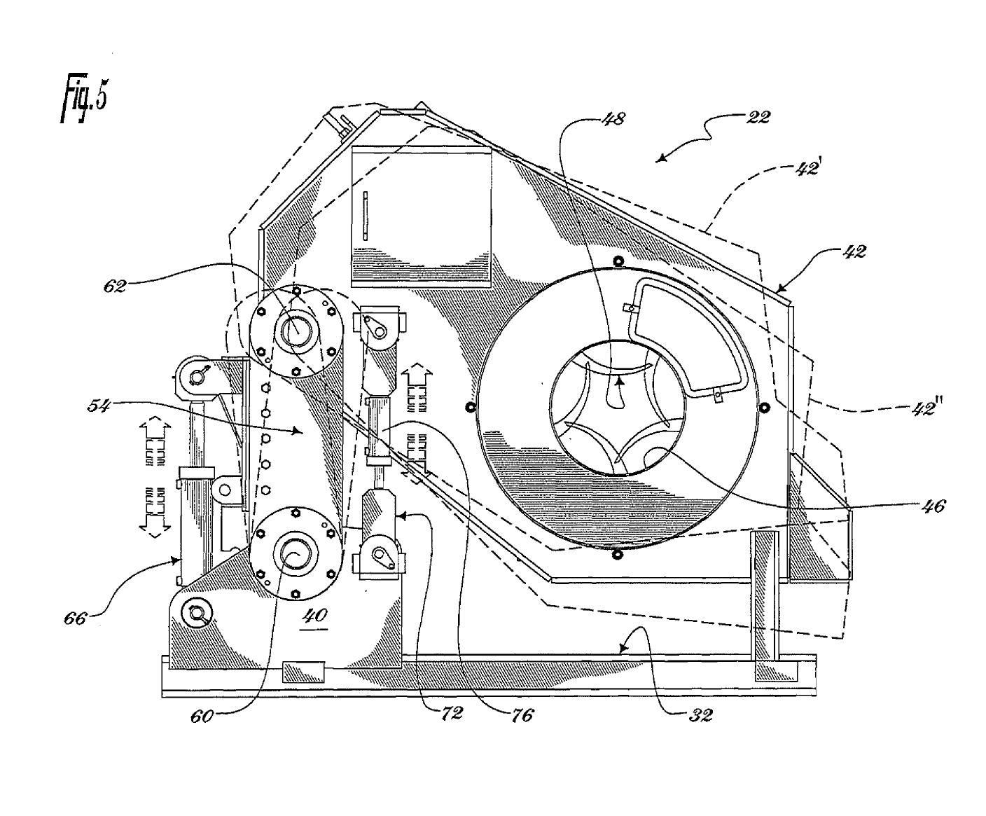

The positional adjustment of debarker movable frame 42 is accomplished by controlling the first and second actuators 66, 72. FIG. 5 suggests the positional adjustment of debarker movable frame 42: in full lines, movable frame 42 is located at an intermediate position; in dotted lines at 42′, the movable frame is pivoted at a generally raised positioned; while in dotted lines at 42″, the movable frame is pivoted at a generally lowered position. By retracting or extracting the second hydraulic cylinders 74, 76 of second actuator 72, movable frame 42 will pivot about second pivot joint 62. Also, by retracting or extracting the first hydraulic cylinder 68 of first actuator 66, both the pivot arm member 54 and movable frame 42 will concurrently pivot about first pivot joint 66. By thus controlling the extraction and retraction of first and second hydraulic cylinders 68 and 74, 76, it consequently becomes possible to adjust the position of movable frame 42 not only horizontally along base 50 but also vertically towards and away from base 50. By definition, each pivotal displacement of movable frame 42 individually about one of first or second pivot joints 60, 62 will in fact result in both a horizontal and a vertical displacement of housing 66; however, by controlling simultaneously both the first and second actuators it becomes possible to have purely horizontal or vertical displacements if desired. Also, it should be noted that due to the geometry and relative positioning of the first and second actuators 66, 72 and the pivot arm member 54 and their attachments to base 21 and to movable frame 42, extraction/retraction of the second actuator 72 results mostly in a vertical displacement of housing 66 while extraction/retraction of the first actuator 66 results mostly in a horizontal displacement of housing 66.

Control device 30 may thus receive log shape input data from scanners 120, 122, 124, 126 and compute log shape information that corresponds to the shape of the log being processed. Although a complete 3-D rendering of the log could thus be computed, it is often unnecessary and perhaps even undesirable. Indeed, cutting tool 48 works at high rotation speed and often force the log to rotate while it is being debarked. Consequently, the actual position and shape of the log will vary not only longitudinally as it advances, but also peripherally as it rotates, so new instant log cross-section data at the debarker position is preferably computed continuously.

Based on this continuous cross-section data at the debarker position, control device 30 will control the position of inlet and outlet conveyors 23, 25 and debarker movable frame 42 not only according to the shape of the entire log but also specifically according to the precise shape and position of the log section which is being debarked at the debarker cutting tool position. It is understood that although no seamier is located at the exact cutting tool position, first scanner 120 may be located at mere inches of cutting tool 48 and, considering that the longitudinal advance speed of the log is known, control device 30 will be able to calculate a very precise approximation of the log shape and position at the cutting tool position. This will allow the log section located at the debarker position to be maintained substantially centrally within log feed opening 46 and its tangent to be mostly parallel to the debarking assembly longitudinal axis, thereby accommodating irregular log shapes and allowing logs with such irregular peripheral surfaces to be properly engaged by the cutting tool 48 and properly debarked.

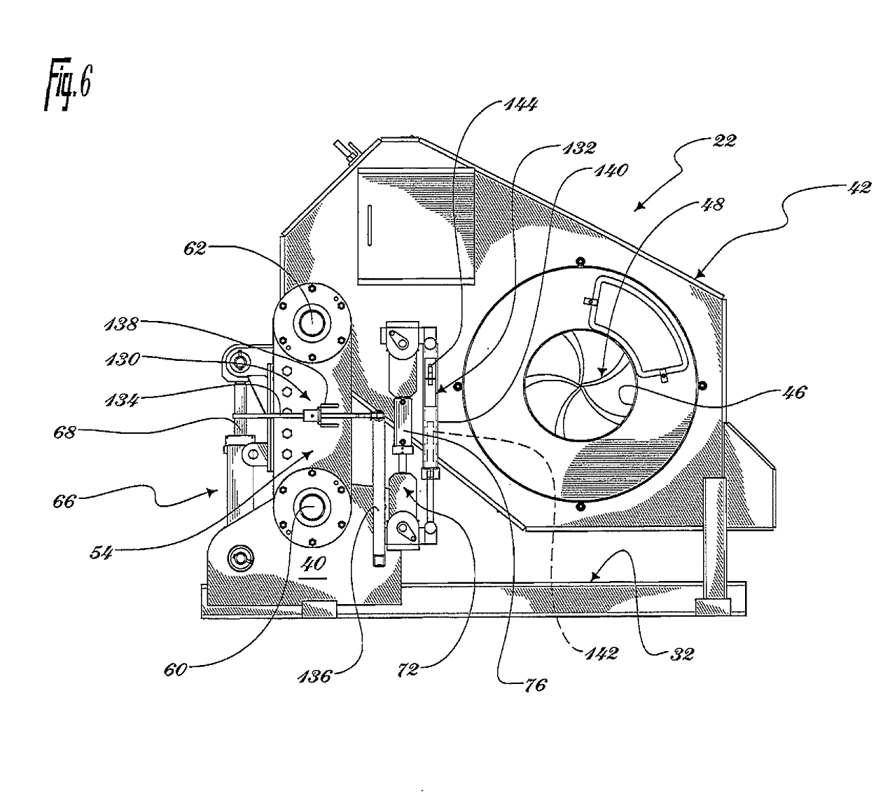

FIG. 6 shows one way to measure the position of debarker movable frame 42. In this embodiment, debarker 22 is identical to that shown in FIGS. 1-5 except that it is equipped with first and second positional sensors 130, 132.

First positional sensor 130 comprises an elongated sensor rod 134 that is pivotally attached at a first end atop a support bar 136 that is fixed to pivot arm support plate 40 of base 32. Sensor rod 134 slidingly engages a sensor reference socket 138 that is pivotally fixed to pivot arm member 54. Any sliding displacement of sensor rod 134 within reference socket 138 will be detected and, through a simple correlation calculated at control device 30, will yield corresponding calculated positional displacements of the center of log opening 46 relative to first pivot joint 60.

Second positional sensor 132 comprises a measurement cylinder 140 with a piston 142 movable therein, each of which are attached next to a corresponding one of the two attachments of second hydraulic cylinder 76 to pivot support plate 40 of base 32 and to movable frame 42. The coextensive measurement cylinder and piston 140, 142 are thus parallel to second hydraulic cylinder 76 and of equal length. A positional sensor 144 located in measurement cylinder 140 will measure any displacement of piston 142, which will be equal to any displacement of second cylinder 76. Through a simple correlation calculated at control device 30, any measured displacement of measurement piston 142 will yield a calculated pivotal displacement of the center of log opening 46 about second pivot joint 62.

It is noted that throughout the present specification, reference to log shape means the outer geometry of the log, i.e. the shape of its outer peripheral surface which is likely to be irregular and which will vary from one log to the next. Reference to the log position means not only its spatial positioning but also its angle or alignment relative to the debarking assembly longitudinal axis.

1. A log debarking assembly for removing bark from logs and defining an upstream end for logs to be debarked to be fed into said log debarking assembly and a downstream end for debarked logs to be outputted, said log debarking assembly comprising:
a auto-aligning ring debarker comprising:
a base;
a movable frame carried by said base and movable relative to said base;
a log opening formed in said movable frame;
a ring-type cutting tool mounted to said movable frame and protruding in said log opening, said cutting tool for debarking logs that are fed through said log opening; and
a powered debarker actuator assembly capable of selectively moving said movable frame relative to said base;
a log shape and position detector comprising a first scanner located upstream of said debarker for detecting the shape and position of logs at the location of said first scanner and for generating first log data as a result of detected log shape and position at the location of said first scanner; and
a control device capable of receiving said first log data and of controlling said powered debarker actuator assembly as a result of said first log data;
wherein the position of said movable frame may be adjusted for adjusting the position of said log opening and said cutting tool relative to the logs being fed through said log opening to be debarked.

2. A log debarking assembly as defined in claim 1, wherein said movable frame is carried by said base by means of a pivot arm member pivotally attached to said base about a first pivot mount and further pivotally attached to said movable frame about a second pivot mount thus allowing said movable frame to pivot relative to said base about said first and second pivot mounts.

3. A log debarking assembly as defined in claim 2, wherein said powered debarker actuator assembly comprises a first actuator selectively forcing said movable frame to move about said first pivot mount and a second actuator selectively forcing said movable frame to move about said second pivot mount.

4. A log debarking assembly as defined in claim 3, wherein said movable frame comprises opposite first and second ends, with said pivot arm member and said first and second actuators being linked to said movable frame near said first end and with said log opening being located near said second end, said movable frame second end thus being supported in cantilever fashion.

5. A log debarking assembly as defined in claim 4, wherein said first actuator comprises a first hydraulic cylinder having a first end linked to said base and a second end linked to said pivot arm member away from said first pivot mount towards said second pivot mount, with the retraction and extraction of said first hydraulic cylinder resulting in pivotal displacement of both said pivot arm member and said movable frame about said first pivot mount.

6. A log debarking assembly as defined in claim 4, wherein said second actuator comprises at least one second hydraulic cylinder parallel to and spaced from said pivot arm member and having a first end linked to said base and a second end linked to said movable frame, with the retraction and extraction of said second hydraulic cylinder resulting in pivotal displacement of said movable frame about said second pivot mount.

7. A log debarking assembly as defined in claim 1, further comprising an inlet conveyor located upstream of said debarker for feeding logs into said debarker, with said first scanner located upstream of said debarker and downstream of said inlet conveyor for detecting the shape and position of logs between said debarker and said inlet conveyor and for generating said first log data as a result of detected log shape and position between said debarker and said inlet conveyor.

8. A log debarking assembly as defined in claim 7, wherein the position of said inlet conveyor is adjustable by means of a powered inlet conveyor actuator assembly for allowing the position of said log to be adjusted as it is fed towards said debarker.

9. A log debarking assembly as defined in claim 8, wherein said log shape and position detector comprises a second scanner located upstream of said inlet conveyor for detecting the shape and position of logs upstream of said inlet conveyor and for generating second log data as a result of detected log shape and position upstream of said inlet conveyor, with said control device receiving said second log data and controlling said powered debarker actuator assembly and said inlet conveyor actuator assembly as a result of said first and second log data.

10. A log debarking assembly as defined in claim 9, further comprising an outlet conveyor located downstream of said debarker for receiving and outputting logs exiting said debarker.

11. A log debarking assembly as defined in claim 10, wherein the position of said outlet conveyor is adjustable by means of a powered outlet conveyor actuator assembly for allowing the position of said log to be adjusted as it exits said debarker but is still partly engaged in said debarker.

12. A log debarking assembly as defined in claim 11, wherein said log position and shape detector comprises a third scanner located downstream of said debarker and upstream of said outlet conveyor for detecting the shape and position of logs between said debarker and said outlet conveyor and for generating third log data as a result of detected log shape and position between said outlet conveyor and said debarker, with said control device receiving said third log data and controlling said powered debarker actuator assembly and said inlet and outlet conveyor actuator assemblies as a result of said first, second and third log data.

13. A log debarking assembly as defined in claim 12, wherein said log shape and position detector comprises a fourth scanner located downstream of said outlet conveyor for detecting the shape and position of logs downstream of said outlet conveyer and for generating fourth log data as a result of detected log shape and position downstream of said outlet conveyor, with said control device receiving said fourth log data and controlling said powered debarker actuator assembly and said inlet and outlet conveyor actuator assemblies as a result of said first, second, third and fourth log data.
